(19) United States
(12) Patent Application Publication
(10) Pub. No.: US 2025/0257474 A1
(43) Pub. Date: Aug. 14, 2025

(54) SELF-CLEANING ANODE FOR CATHODIC PROTECTION SYSTEMS, CATHODIC PROTECTION SYSTEMS INCLUDING THE SAME, AND METHODS OF USE

(71) Applicant: Matcor, Inc., Chalfont, PA (US)

(72) Inventors: Theodore Andrew Huck, Berwyn, PA (US); Kevin Groll, Lansdale, PA (US)

(73) Assignee: Matcor, Inc., Chalfont, PA (US)

(21) Appl. No.: 19/049,225

(22) Filed: Feb. 10, 2025

Related U.S. Application Data
(63) Continuation of application No. 17/510,628, filed on Oct. 26, 2021, now Pat. No. 12,221,708.
(60) Provisional application No. 63/107,756, filed on Oct. 30, 2020.

(51) Int. Cl. C23F 13/16; B08B 7/02

(52) U.S. Cl. CPC C23F 13/16; B08B 7/028

(57) ABSTRACT

A self-cleaning anode system for cathodic protection of equipment including a tank in which a liquid to be processed is located. The anode system includes a self-cleaning anode having a titanium body with a catalytic coating thereof. The anode includes at least one piezoelectric transducer for producing ultrasonic vibrations and coupling those vibrations to the catalytic coating on the anode to displace or dislodge any fouling deposits that may have accumulated on the anode during normal its normal operation in cathodically protecting the tank.

### CROSS-REFERENCE TO RELATED PATENT APPLICATIONS

This application is a continuation of U.S. patent Ser. No. 17/510,628, filed on Oct. 26, 2021, which claims the benefit of and priority to U.S. Provisional Patent Application No. 63/107,756, filed on Oct. 30, 2020, each of which is incorporated herein by reference in its entirety.

### FIELD OF THE INVENTION

This invention relates generally to cathodic protection systems where the anode may be subject to fouling and more particularly to self-cleaning anode systems for cathodic protection in these fouling applications, and method of using the same. One such application is process equipment in the oil and gas industry.

### BACKGROUND

Cathodic protection systems have been used to protect process equipment in the oil and gas industry. One such application is the cathodic protection of oil/water separators, knock out vessels and other similar oil processing equipment that is used to process crude oil/produced water emulsions. These vessels are used to separate produced water from oil, as almost all oil production results in mixture of crude oil and water being extracted in a mixed emulsion that must be separated with the water being disposed of and the crude oil being transported for further processing. During the separation process, the produced water is heavier than the crude oil and is generally quite corrosive. Ultimately during the separation process, the crude oil rises and the produced water sinks forming distinct layers. It is this produced water layer where the cathodic protection is required to protect the vessel interior from corrosion. This involves installing one or more anodes through the wall of the vessel, or from the open top of the vessel into this saltwater zone and discharging current off the anode. The anodes often used are large diameter galvanic anodes that have a short service life necessitating frequent replacement.

The use of longer life impressed current mixed metal oxide (MMO) anodes have been tried but one of the challenges is that these anodes struggle with any upset or startup conditions that result in the anode being exposed to the oil/water emulsion or the separated crude oil. Once fouled, (e.g., coated with oil) these anodes are prone to high resistance and cannot discharge enough current to protect the structure. In some cases, the anodes are subject to rapid failure as all the current is discharged off of a very diminished area exceeding the MMO anode's maximum allowable current density for discharging current and resulting in coating damage and accelerated corrosion of the underlying titanium anode substrate.

Accordingly, a need exists for an anode which is self-cleaning, and for a cathodic protection system which makes use of an anode which can be operated to automatically self-clean itself at desired periods of time. The subject invention addresses those needs.

All references cited and/or identified herein are specifically incorporated by reference herein.

### SUMMARY OF THE INVENTION

In accordance with one aspect of this invention there is provided a self-cleaning anode for cathodic protection of equipment including a tank or other structure in which a liquid to be processed is located. At least a portion of the self-cleaning anode is configured to be immersed in the liquid to be processed. The self-cleaning anode comprises a body, a catalytic coating and at least one piezoelectric transducer. The body is formed of titanium and has an exterior surface, at least a portion of which is configured to be immersed in the liquid to be processed and is subject to fouling by fouling deposits accumulating thereon when immersed in the liquid to be processed. The body is configured to be connected to an electrical conductor to discharge electrical current off of at least a portion of the self-cleaning anode when at least a portion of the self-cleaning anode is immersed in the liquid to be processed. The catalytic coating is disposed on at least a portion of the exterior surface. The at least one piezoelectric transducer is coupled to the body and configured to be electrically coupled to an electrical circuit for receipt of electrical energy to cause the at least one piezoelectric transducer to vibrate at an ultrasonic frequency to apply ultrasonic vibrations to the mixed catalytic coating, whereupon the ultrasonic vibrations displace the fouling deposits (e.g., oil and petroleum byproducts) from the catalytic coating.

In accordance with one preferred aspect of the self-cleaning anode, the body comprises a box having a top wall. The top wall having an outer surface on which the mixed metal oxide coating is located and an interior chamber in which the at least one piezoelectric transducer is located.

In accordance with another preferred aspect of the self-cleaning anode, the body comprises an elongated resonator rod having a pair of ends, and wherein the at least one piezoelectric transducer is coupled to at least one of the ends of the rod.

In accordance with another preferred aspect of the self-cleaning anode, each of the pair of ends includes at least one piezoelectric transducer coupled thereto.

In accordance with another preferred aspect of the self-cleaning anode, the elongated resonator rod has a central longitudinal axis, and a central cavity extending along the central longitudinal axis.

In accordance with another preferred aspect of the self-cleaning anode, the ultrasonic frequency is in the range of 25 kHz to 40 kHz.

In accordance with another preferred aspect of the self-cleaning anode, the ultrasonic frequency is approximately 40 kHz.

In accordance with another preferred aspect of the self-cleaning anode, the catalytic coating is selected from the group consisting of an iridium-based mixed metal oxide coating, a ruthenium-based mixed metal oxide coating and a platinum catalytic coating.

In accordance with another preferred aspect of the self-cleaning anode, the mixed metal oxide coating is more than approximately 6 mg/m2 of coating loading.

Another aspect of this invention is system for cleaning an anode in a tank or other structure in which a liquid to be processed is located. The system comprises a controller, a first electrical conductor, a second electrical conductor, and a self-cleaning anode. The first electrical conductor is configured to be connected to a cathodic protection system during a first interval of time under control of the controller. The second electrical conductor is configured to be connected to an electrical circuit providing an electrical signal of a desired frequency during a second interval of time under control of the controller. The self-cleaning anode is configured to be immersed in the liquid to be processed. The self-cleaning anode comprises a body, a catalytic coating and at least one piezoelectric transducer. The body is formed of titanium and has an exterior surface, at least a portion of which is configured to be immersed in the liquid to be processed and is subject to fouling by fouling deposits accumulating thereon when immersed in the liquid. The body is connected to the first electrical conductor to discharge electrical current off of the at least a portion of the self-cleaning anode to the cathodic protection system during the first interval of time when the at least a portion of the self-cleaning anode is immersed in the liquid. The catalytic coating is disposed on at least a portion of the exterior surface. The at least one piezoelectric transducer is coupled to the body and is connected to the second electrical connector, whereupon the electrical signal of a desired frequency is provided to the at least one piezoelectric transducer causes the at least one piezoelectric transducer to produce ultrasonic vibrations and apply the ultrasonic vibrations to the catalytic coating during the second interval of time when the at least a portion of the self-cleaning anode is immersed in the liquid to be processed to displace the fouling deposits from the catalytic coating during the second interval of time.

In accordance with one preferred aspect of the system for cleaning an anode in a tank or other structure in which a liquid to be processed is located, the body comprises a box having a top wall. The top wall has an outer surface on which the catalytic coating is located and an interior chamber in which the at least one piezoelectric transducer is located.

In accordance with another preferred aspect of the system for cleaning an anode in a tank or other structure in which a liquid to be processed is located, the body comprises an elongated resonator rod having a pair of ends, and wherein the at least one piezoelectric transducer is coupled to at least one of the ends of the rod.

In accordance with another preferred aspect of the system for cleaning an anode in a tank or other structure in which a liquid to be processed is located, each of the pair of ends includes at least one piezoelectric transducer coupled thereto.

In accordance with another preferred aspect of the system for cleaning an anode in a tank or other structure in which a liquid to be processed is located, the elongated resonator rod has a central longitudinal axis, and a central cavity extending along the central longitudinal axis.

In accordance with another preferred aspect of the system for cleaning an anode in a tank or other structure in which a liquid to be processed is located, the ultrasonic frequency is in the range of 25 kHz to 40 kHz.

In accordance with another preferred aspect of the system for cleaning an anode in a tank or other structure in which a liquid to be processed is located, the ultrasonic frequency is approximately 40 kHz.

In accordance with another preferred aspect of the system for cleaning an anode in a tank or other structure in which a liquid to be processed is located, the catalytic coating is selected from the group consisting of an iridium-based mixed metal oxide coating, a ruthenium-based mixed metal oxide coating, and a platinum catalytic.

In accordance with another preferred aspect of the system for cleaning an anode in a tank or other structure in which a liquid to be processed is located, the mixed metal oxide coating is more than approximately 6 mg/m2 of the coating load.

Another aspect of this invention is a method for cathodic protection of processing equipment including a tank or other structure in which a liquid to be processed is located, comprising. The method comprises providing a self-cleaning anode comprising a body and at least one piezoelectric transducer coupled to the body. The body is formed of titanium and has an exterior surface in the form of a mixed metal oxide coating disposed on at least a portion of the exterior surface. At least a portion of the self-cleaning anode is immersed in the liquid to be processed. The at least a portion of the self-cleaning anode is subject to fouling by fouling deposits accumulating thereon when immersed in the liquid to be processed. The self-cleaning anode is coupled to a cathodic protection system, whereupon the self-cleaning anode discharges electrical current off of the at least a portion of the self-cleaning anode to the cathodic protection system during a first interval of time when the at least a portion of the self-cleaning anode is immersed in the liquid to be processed. The at least one piezoelectric transducer is coupled to an electrical circuit providing an electrical signal of a desired frequency during a second interval of time when the at least a portion of the self-cleaning anode is immersed in the liquid to be processed, whereupon the at least one piezoelectric transducer produces ultrasonic vibrations and applies the ultrasonic vibrations to the mixed metal oxide coating during the second interval of time when the at least a portion of the self-cleaning anode is immersed in the liquid to be processed to displace the fouling deposits from the mixed metal oxide coating during the second interval of time.

In accordance with one preferred aspect of the method for cathodic protection of processing equipment including a tank or other structure in which a liquid to be processed is located, the first and second periods of time are different time periods, which do not overlap.

In accordance with another preferred aspect of the method for cathodic protection of processing equipment including a tank or other structure in which a liquid to be processed is located, the self-cleaning anode is electrically isolated from the cathodic protection system during the second interval of time.

In accordance with another preferred aspect of the method for cathodic protection of processing equipment including a tank or other structure in which a liquid to be processed is located, the self-cleaning anode is electrically isolated from the electrical circuit providing an electrical signal of a desired frequency during the first interval of time.

In accordance with another preferred aspect of the method for cathodic protection of processing equipment including a tank or other structure in which a liquid to be processed is located, the isolation of the self-cleaning anode from the cathodic protection system and from the electrical circuit providing an electrical signal of a desired frequency is controlled automatically by a controller.

In accordance with another preferred aspect of the method for cathodic protection of processing equipment including a tank or other structure in which a liquid to be processed is located, the equipment is selected from the group consisting of oil/water separators, knock out vessels and other oil processing equipment that is used to process crude oil/produced water emulsions.

### BRIEF DESCRIPTION OF THE DRAWINGS

FIG. 1 is an isometric view of a portion of a tank of one exemplary piece of equipment, e.g., an oil/water separation unit, in which one exemplary embodiment of self-cleaning anode constructed in accordance with this invention is mounted for the cathodic protection of the tank;

FIG. 2 is an enlarged exploded isometric view of the exemplary self-cleaning anode shown in FIG. 1;

FIG. 3 is an enlarged side elevation view of one end of the self-cleaning anode shown in FIGS. 1 and 2;

FIG. 4 is an enlarged top plan view of the self-cleaning anode shown in FIGS. 1-3;

FIG. 5 is an isometric view of a portion of a tank of the exemplary piece of equipment, e.g., an oil/water separation unit, like shown in FIG. 1, but with another exemplary embodiment of self-cleaning anode constructed in accordance with this invention is mounted for the cathodic protection of the tank;

FIG. 6 is an enlarged isometric view of the exemplary self-cleaning anode shown in FIG. 5; and

FIG. 7 is a reduced isometric view of another exemplary embodiment of a self-cleaning anode constructed in accordance with this invention.

### DETAILED DESCRIPTION

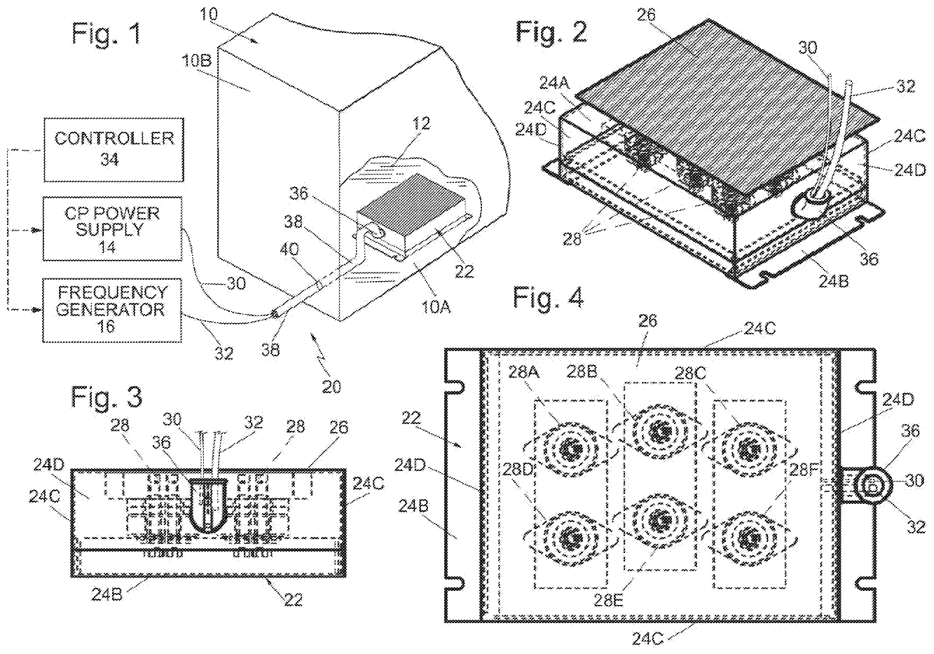

Referring now to the various figures of the drawing wherein like reference characters refer to like parts, there is shown at 20 in FIG. 1 one exemplary embodiment of a self-cleaning anode system 20 including a self-cleaning anode 22 forming a portion of a cathodic protection system for the cathodically protecting liquid processing equipment including a tank 10 (or other structure) in which a liquid to be processed is located. That equipment can be of any type. One particular type is process equipment in the oil and gas industry, such oil/water separators, knock-out vessels and other similar oil processing equipment used to process crude oil/produced water emulsions. It should be noted that the tank 10 shown in FIG. 1 is merely one example of various shaped and sized tanks or other structures holding the liquid to be processed for which the subject invention can be used.

The self-cleaning anode 22 is designed so that at least a portion of it is located within the tank 10 and immersed in the liquid 12 to be processed. When in the liquid 12 the outer surface of the self-cleaning anode, like other cathodic protection anodes immersed in a liquid to be processed, is subject to becoming fouled by the accumulation of fouling deposits, e.g., oil, thereon. Such fouling action, unless impeded, will over time degrade the ability of the anode to discharge electrical current off of it and hence prevent the cathodic protection system from working properly.

The self-cleaning anode of the subject invention is configured so that periodically it can be operated to clean itself of the accumulating fouling deposits. The self-cleaning anode 22 basically comprises a body 24 that has an outer surface, a portion of which is in the form of a catalytic coating 26. Unlike conventional anodes, the self-cleaning anode 22 of this invention includes at least one piezoelectric transducer 28 coupled to the body 24. The at least one piezoelectric transducer is configured to produce and apply ultrasonic vibrations to the body, whereupon any fouling deposits that had accumulated on the catalytic coating 26 will be dislodged by cavitation resulting from those ultrasonic vibrations.

The body 24 can be of various shapes and sizes depending upon the application and can be located at any desired location within the tank 10. In the exemplary embodiment shown in FIG. 1, the self-cleaning anode 22 is shown located and mounted on the floor 10A (or bottom wall) of the tank 10, so that it will be immersed in any processing liquid 12 that is introduced into the tank.

The body of the exemplary embodiment shown in FIGS. 1-4, is in the form of a hollow box-like housing, whose details will be described later. Suffice it for now to state that the box-like body includes at least one piezoelectric transducer is located in it. A portion of a first electrical conductor or cable 30 is electrically connected to the body at some internal connection point (not shown). The first electrical conductor or cable 30 includes another portion that is configured to be connected to a Cathodic Protect (CP) Power Supply 14 of the cathodic protection system to discharge electrical current off of the self-cleaning anode 22 when the cathodic protection system is in its normal operating mode. A second electrical conductor or cable 32 is electrically connected to the at least one piezoelectric transducer 28 and includes an end portion that is configured to be connected to a Frequency Generator 16. The Frequency Generator 16 is configured to provide an electrical signal of a desired frequency to the at least one piezoelectric transducer to cause it/them to vibrate at an ultrasonic frequency during selected time periods when normal operation of the cathodic protection system is interrupted and cleaning of the self-cleaning anode is to be accomplished. It is during those selected time periods, to be described later (each referred to hereinafter as the “self-cleaning period”, or the “self-cleaning cycle”, or the “self-cleaning mode”), that any fouling deposits that had accumulated on catalytic coating 26 will be dislodged by the operation of the at least one piezoelectric transducer.

The body 24 the embodiment shown in FIGS. 1-4 is preferably formed of titanium, which is very pure (e.g., approximately at least 99% titanium) and has a top wall 24A (FIG. 2), a flanged bottom wall 24B, a pair of side walls 24C, and a pair of end walls 24D. The outer surface of the top wall is in the form of the catalytic coating 26. The catalytic coating is preferably a mixed metal oxide (MMO) coating (e.g., an iridium-based mixed metal oxide coating or a ruthenium-based mixed metal oxide coating), or a platinum catalytic coating, like used in prior art cathodic protection anodes. In accordance with one preferred embodiment the thickness of the coating 26 is very thin, e.g., more than approximately 6 mg/m² of the coating load.

As best seen in FIG. 4 the self-cleaning anode 22 of FIG. 1 includes a total of six piezoelectric transducers, namely, transducers 28A, 28B, 28C, 28D, 28E and 28F, each of which is fixedly mounted within the hollow interior of the box-like body 24. The mounting of the anode 22 within the tank 10 can be accomplished by securing the flanges of the bottom wall 24B to the floor 10A of the tank by any suitable means, e.g., screws, etc., (not shown).

Each of the transducers includes a portion that is coupled to the inner surface of the top wall 24A so that when energized the piezoelectric elements of the transducers vibrate to apply ultrasonic vibrations to the top wall 24A, which ultrasonic vibrations propagate through the top wall to the catalytic coating 26.

In accordance with one preferred embodiment of this invention each piezoelectric transducer is a conventional device, like those used in the Immersible Ultrasonic Transducers that are available from Crest Ultrasonics Corporation. Piezoelectric ultrasonic transducers of other manufacturers can be used for the subject invention, as well. Each of the piezoelectric transducers is connected to the cable 32, which as described above is configured to be connected to the Frequency Generator 16. The Frequency Generator 16 is also preferably a conventional device like the Ultrasonic Generators available from Crest Ultrasonics Corporation, but other frequency generators of other manufacturers can be used as well.

In any case it is preferred that the Frequency Generator be configured so that it provides electrical signals to the piezoelectric transducers to cause them to vibrate at a frequency in the range of approximately 20 kHz to approximately 100 kHz and preferably approximately 25 kHz to approximately 40 kHz. For applications involving processing crude oil/produced water emulsions a frequency of approximately 40 kHz is preferred.

It should be noted that other frequency ranges and other preferred frequencies can be implemented depending upon the type of processing liquid in which the self-cleaning anode of this invention is immersed.

In accordance with one preferred aspect of this invention and in order to establish the normal operating mode of the cathodic protection system and the self-cleaning mode, the self-cleaning anode system 20 includes a Controller 34. The Controller 34 is an electronic circuit that is configured and operative for interrupting the normal operation of the cathodic protection system (e.g., turning off the CP Power Supply 14 of the cathodic protection system) and initiating the self-cleaning mode (e.g., turning on the Frequency Generator 16). During the self-cleaning mode or cycle the Frequency Generator 16 applies electrical drive signals to the ultrasonic transducers 30A-30F to cause them to operate (vibrate at an ultrasonic frequency) to dislodge the accumulated fouling deposits from the catalytic coating 26 of the anode 22.

The initiation of the self-cleaning mode or cycle can be accomplished under control of the Controller 34 periodically, e.g., self-cleaning for a time period of 10 minutes at a prescribed time once a day. Alternatively, the Controller may control the initiation of the self-cleaning mode or cycle on an as-needed basis, i.e., upon detection of fouling of the anode. That alternative operation can be accomplished by the Controller 34 monitoring the resistance of the anode 22, whereupon if the anode's resistance rises to a predetermined value (thereby indicating that the anode has become fouled), the Controller 34 will initiate the self-cleaning mode or cycle. Coincident with the initiation of the self-cleaning mode or cycle, the Controller 34 will interrupt the normal mode of operation of the self-cleaning anode by turning off the CP Power Supply 14. Once the Controller determines that the self-cleaning anode has been cleaned sufficiently, i.e., its resistance has dropped below a predetermined threshold, the CP Power Supply 14 will be turned back on by the Controller 34 to initiate the normal mode of operation. At the same time the Controller 34 will terminate the self-cleaning mode or cycle, i.e., turning off the Frequency Generator 16. The electrical signals from the Controller 34 to the CP Power Supply 14 and the Frequency Generator 16 to control their operation (i.e., turn them off and on), are shown schematically by the broken lines with arrowheads in FIG. 1.

As best seen in FIG. 1, the cables or conductors 30 and 32 extend out of the box-like housing 24 via an elbow shaped conduit 36 and an associated conduit 38. The conduit 38 passes through a mount (not shown), e.g., a flange with a sealing gasket, a threaded connector, etc., forming a pressure sealed opening 40 in a side wall 10B of the tank 10 from which the cable or conductor 30 connects to the CP Power Supply 14 and the cable or conductor 32 connects to the Frequency Generator 16.

It should be noted that the number and placement of piezoelectric transducers utilized in the anode 22 depends upon the application, with the goal of enhancing the creation of a homogenous sonic field across the entire top surface of the anode. Moreover, the use of the catalytic coating 26 on only the top wall 24A of the box-like housing 24 is merely exemplary of various configurations for the catalytic coating. In this regard, the catalytic coating 26 can be applied to all of the walls of the housing which will be exposed to the processing liquid 12, or can be applied to selected ones of the walls depending upon circumstances and the shape and size of the housing 24.

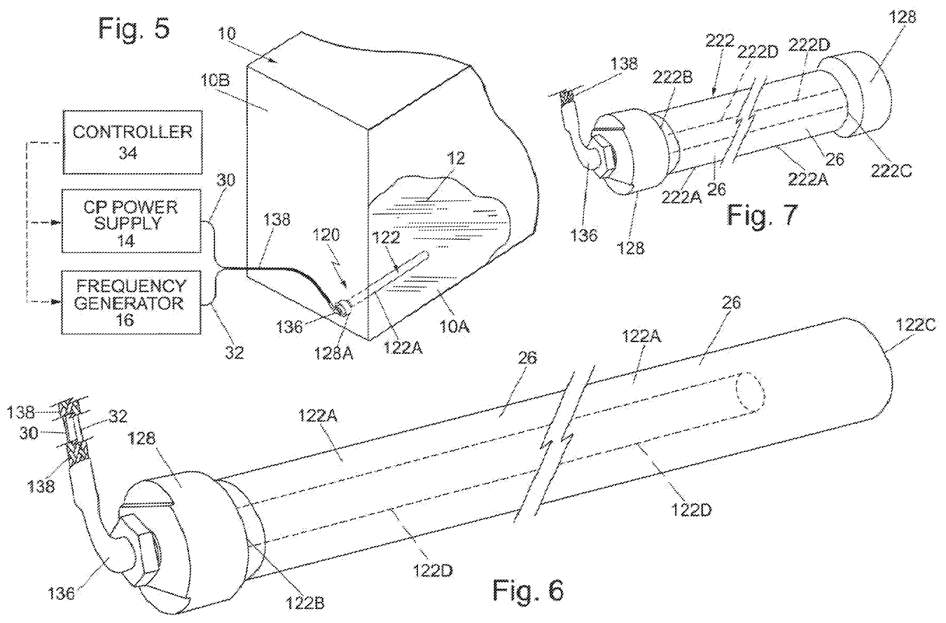

FIG. 5 shows another embodiment of a self-cleaning anode system 120 including an alternative self-cleaning anode 122 forming a portion of a cathodic protection system for cathodically protecting liquid processing equipment like that of FIG. 1. In the interest of brevity the common components of the system 120 and the system 20 will be given the same reference numbers and the details of their construction, arrangement and operation will not be reiterated. Thus, as can be seen the anode system 120 includes the heretofore identified Frequency Generator 16 and Controller 34. The self-cleaning anode 122 basically comprises an elongated, cylindrical body 122A having a pair of ends 122B and 122C. The end 122C is closed. The body 122A is formed of the same material as that making up the body 22 (i.e., pure titanium), whose outer periphery is coated with a catalytic coating 126 formed of the same material as the catalytic coating 26. The coating 126 is of the same thickness as the coating 26, i.e., more than approximately 6 mg/m2 of the coating load. The body 122A is constructed similarly to like that of resonator rod of a Single Push Transducer available from Crest Ultrasonics Corporation, except for the titanium material making up the body and its catalytic coating. An ultrasonic drive head 128 is mounted at the end 122B of the body 122A. The ultrasonic drive head 128 includes a piezoelectric ultrasonic transducer, like that found in the Crest Ultrasonics Corporation Single Push Transducer. The resonator rod includes a central cavity 122D extending longitudinally along the central longitudinal axis of the body from ultrasonic drive head 128 to a point adjacent the closed end 122C.

The self-cleaning anode 122 is mounted on the tank 10 so that the drive head 128 is located outside the tank closely adjacent the side wall 10B, and with a portion of the anode body passing through a pressure sealed opening in that side wall so that the remainder of the anode is located within the interior the tank. The means for mounting the anode on the tank through the pressure sealed opening can take various forms, e.g., can be a flanged mount with a seal or gasket, a threaded connection, etc. In any case, one portion of an electrical conductor or cable 30 is electrically connected to the body 122 at some internal connection point (not shown) and extends out of an elbow conduit 136 at outermost end of the drive head 128. One portion of another electrical conductor 32 is electrically connected to the piezoelectric transducer of the ultrasonic drive head 128 at some internal connection point (not shown) and also extends out of the elbow 136. The two conductors or cables 30 and 32 exit the elbow 136 within a braided protective sleeve 138. The end of the conductor or cable 30 exiting from the braided sleeve 138 is electrically connected to the CP Power Supply 14, while the end of the conductor or cable 32 exiting from the protective sleeve is electrically connected to the Frequency Generator 16.

The self-cleaning anode 122 operates in the same modes or operation as the self-cleaning anode 22, under control of the Controller 34. In particular, when the Controller determines that the self-cleaning anode should operate in the cleaning mode or cycle, the Controller will provide an appropriate signal to the CP Power Supply 14 to turn it off, thereby terminating the normal cathodic protection operation of the anode, and at the same time provide an appropriate signal to the Frequency Generator 16 to turn it on. When the Frequency Generator is turned on it will provide the electrical signals to the ultrasonic transducer in the drive head 128 to cause it to vibrate at the desired ultrasonic frequency like that of the self-cleaning anode system 20, whereupon the vibrations will be coupled through the resonator rod 122A and its cavity 122D to the catalytic coating 126 on the resonator rod to dislodge the accumulated fouling deposits from that coating. Once the cleaning mode cycle or mode is completed, the Controller 34 will turn the Frequency Generator 16 off, and will turn the CP Power Supply 14 on, whereupon normal cathodic protection operation will re-commence.

FIG. 7 shows an alternative embodiment of a self-cleaning anode 222 constructed in accordance with this invention. The self-cleaning electrode 222 can form a portion of the heretofore-identified self-cleaning anode system 120 in lieu of the self-cleaning anode 122. In the interest of brevity the common components of the self-cleaning anode 222 and 122 will be given the same reference numbers and their construction, arrangement and operation will not be reiterated. Thus, as can be seen in FIG. 7, the self-cleaning anode 222 basically comprises an elongated, cylindrical body 222A having a pair of ends 222B and 222C. The body 222A is formed of the same material as that making up the body 122 (i.e., pure titanium), whose outer periphery is coated with a catalytic coating 126 formed of the same material as the catalytic coating 26. The coating 126 is of the same thickness as the coating 26, i.e., more than approximately 6 mg/m2 of the coating load. The body 222A is constructed similarly to like that of resonator rod of the Push-Pull Transducer available from Crest Ultrasonics Corporation, except for the titanium material making up the body and its catalytic coating. A first ultrasonic drive head 128 is mounted at the end 222B and a second ultrasonic drive head 128 is mounted at the end 222C. Each ultrasonic drive head 128 includes a piezoelectric ultrasonic transducer, like that found in the Crest Ultrasonics Corporation Push-Pull Transducer. The resonator rod includes a central cavity 222D extending longitudinally along the central longitudinal axis of the body between the two ultrasonic drive heads 128.

The self-cleaning anode 222 is mounted on the tank 10 in the same manner as the self-cleaning anode 122 is mounted on that tank, and is connected to the CP Power Supply 14 and to the Frequency Generator 16 in the same manner as well. Operation of the self-cleaning anode 222 is the same as that described with respect the self-cleaning anode 122, except that during the self-cleaning mode of operation the fouling-removing vibrations are provided by the two ultrasonic drive heads 128. Thus the two drive heads operate induce longitudinal pulses in the resonator rod 222A at their respective points of attachment, thereby enhancing the creation of a homogenous sonic field along the resonator rod

It should be noted that the exemplary embodiments of the systems 20, 120 and 220 are but a few examples of various structures and configurations that can be made in accordance with this invention to carry out its ends. Moreover, the methods of use of the self-cleaning anodes and the systems in which they are used as disclosed above should not be deemed to constitute all of the methods and systems of the subject invention, nor should the use of such methods and systems be limited to cathodic protection of oil/water separators, knock out vessels and other similar oil processing equipment that is used to process crude oil/produced water emulsions. Thus, the subject invention is contemplated for use in other applications where similar types of fouling is an issue.

Without further elaboration the foregoing will so fully illustrate our invention that others may, by applying current or future knowledge, adopt the same for use under various conditions of service.

1-20. (canceled)

21. A cathodic protection system comprising:
a tank;
an anode arranged within the tank and including:
a body including a plurality of walls that define an internal volume;
a catalytic coating disposed on an external surface of at least one of the plurality of walls; and
an ultrasonic transducer arranged within the internal volume and coupled to an internal surface of at least one of the plurality of walls; and
a controller in communication with the ultrasonic transducer and configured to selectively energize the ultrasonic transducer to apply ultrasonic vibrations to the body of the anode.

22. The cathodic protection system of claim 21, further comprising a plurality of ultrasonic transducers, each being coupled to the internal surface.

23. The cathodic protection system of claim 21, wherein the external surface and the internal surface are both formed on a first wall of the plurality of walls.

24. The cathodic protection system of claim 21, wherein the controller is configured to selectively energize the ultrasonic transducer according to a periodic schedule that includes energizing the ultrasonic transducer for a predefined length of time in periodic intervals.

25. The cathodic protection system of claim 21, wherein the controller is configured to monitor a resistance of the anode.

26. The cathodic protection system of claim 25, wherein the controller is configured to selectively energize the ultrasonic transducer in response to the resistance of the anode increasing to an upper threshold.

27. The cathodic protection system of claim 26, wherein the controller is configured to maintain the ultrasonic transducer in an energized state until the resistance of the anode decreases to a lower threshold.

28. The cathodic protection system of claim 21, further comprising a power supply electrically coupled to the anode.

29. The cathodic protection system of claim 28, wherein the controller is in communication with the power supply, and wherein the controller is configured to selectively transition the anode between a normal mode where the ultrasonic transducer is de-energized and the power supply provides electrical power to the anode and a self-cleaning mode where the power supply is inhibited from providing electrical power to the anode and the ultrasonic transducer is energized.

30. The cathodic protection system of claim 29, wherein the controller is configured to transition the anode from the normal mode to the self-cleaning mode according to a periodic schedule that includes energizing the ultrasonic transducer for a predefined length of time in periodic intervals.

31. The cathodic protection system of claim 29, wherein the controller is configured to monitor a resistance of the anode.

32. The cathodic protection system of claim 31, wherein the controller is configured to transition the anode from the normal mode to the self-cleaning mode in response to the resistance of the anode increasing to an upper threshold.

33. The cathodic protection system of claim 32, wherein the controller is configured to transition from the self-cleaning mode to the normal mode when the resistance of the anode decreases to a lower threshold.

34. A cathodic protection system comprising:
a power supply;
a frequency generator;
an anode arranged including:
a body;
a catalytic coating disposed on an external surface the body; and
an ultrasonic transducer coupled to the body; and
a controller in communication with the power supply, the frequency generator, and the ultrasonic transducer, the controller being configured to selectively transition the anode between a normal mode and a self-cleaning mode,
in the normal mode, the controller instructs the power supply to provide electrical power to the anode and prevents electrical communication between the frequency generator and the ultrasonic transducer, and
in the self-cleaning mode, the controller prevents electrical communication between the power supply and the anode and instructs the frequency generator to energize the ultrasonic transducer to apply ultrasonic vibrations to the body of the anode.

35. The cathodic protection system of claim 34, wherein the controller is configured to transition the anode from the normal mode to the self-cleaning mode according to a periodic schedule that includes energizing the ultrasonic transducer, via the frequency generator, for a predefined length of time in periodic intervals.

36. The cathodic protection system of claim 34, wherein the controller is configured to monitor a resistance of the anode.

37. The cathodic protection system of claim 36, wherein the controller is configured to transition the anode from the normal mode to the self-cleaning mode in response to the resistance of the anode increasing to an upper threshold.

38. The cathodic protection system of claim 37, wherein the controller is configured to transition from the self-cleaning mode to the normal mode when the resistance of the anode decreases to a lower threshold.

39. A self-cleaning anode system comprising:
a body electrically coupled to a power supply;
a catalytic coating disposed on an external surface the body;
an ultrasonic transducer coupled to the body; and
a controller in communication with the power supply and the ultrasonic transducer, the controller being operable in a normal mode and a self-cleaning mode,
in the normal mode, the controller instructs the power supply to provide electrical power to the body, and
in the self-cleaning mode, the controller energizes the ultrasonic transducer to apply ultrasonic vibrations to the body.

40. The self-cleaning anode system of claim 39, wherein the controller is configured to (a) transition from the normal mode to the self-cleaning mode according to a periodic schedule that includes energizing the ultrasonic transducer for a predefined length of time in periodic intervals, or (b) transition from the normal mode to the self-cleaning mode in response to a resistance of the body increasing to an upper threshold.
